(19) United States
(12) Patent Application Publication
(10) Pub. No.: US 2008/0165287 A1
(43) Pub. Date: Jul. 10, 2008

(54) Framebuffer Sharing for Video Processing

(76) Inventors: Daniel Doswald, Munich (DE); Keith S.K. Lee, Markham (CA); Samir N. Hulyalkar, Newtown, PA (US)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(21) Appl. No.: 11/847,802

(22) Filed: Aug. 30, 2007

Related U.S. Application Data
(60) Provisional application No. 60/841,404, filed on Aug. 30, 2006.

(51) Int. Cl. H04N 9/64

(52) U.S. Cl. 348/718; 348/E09.037

(57) ABSTRACT

An integrated circuit chip configured to be coupled to a single shared memory including, in combination, a memory access module, at least one video signal processing module, and a frame rate converter, wherein the memory access module is configured to coordinate access to the single shared memory by the at least one video signal processing module and the frame rate converter.

### CROSS-REFERENCE TO RELATED ACTIONS

This application claims the benefit of U.S. Provisional Application No. 60/841,404, filed Aug. 30, 2006, which is incorporated by reference herein in its entirety.

### BACKGROUND

The use of video information, which can contain corresponding audio information, is a widespread source of information and is becoming more widespread every day. Not only is more video information used and/or conveyed, but the information is more complex as more information is contained in video transmissions. Along with the increase in content is a desire for faster processing of the video information, and reduced cost to process the information.

Existing digital television receivers use multiple integrated circuit chips to process video information. For example, one chip may be used to provide back-end processing such as video decoding, audio processing, deinterlacing, scaling, etc. while another chip is used to provide frame rate conversion. The back-end processing chip and the frame rate converter chip use separate memories, occupying separate space and using separate memory calls. The back-end processor memory may store information that is also stored in the frame rate converter memory for use by the frame rate converter.

### SUMMARY

In general, in an aspect, implementations of the invention may provide an integrated circuit chip configured to be coupled to a single shared memory including, in combination, a memory access module, at least one video signal processing module, and a frame rate converter, wherein the memory access module is configured to coordinate access to the single shared memory by the at least one video signal processing module and the frame rate converter.

Implementations of the invention may provide one or more of the following features. The at least one video signal processing module and the frame rater converter are configured to share algorithm information. The at least one video signal processing module is configured to store intermediate results in the single shared memory and the frame rater converter is configured to further process the intermediate results using the single shared memory. The at least one video signal processing module comprises a video decoder module. The at least one video signal processing module comprises a deinterlacer. The at least one video signal processing module comprises a scaler.

In general, in another aspect, implementations of the invention may provide a digital television receiver including a memory, a single integrated circuit chip including, in combination, a memory access module, at least one video signal processing module, and a frame rate converter, wherein the memory access module is configured to coordinate access to the memory by the at least one video signal processing module and the frame rate converter.

Implementations of the invention may also provide one or more of the following features. The at least one video signal processing module and the frame rate converter are configured to share algorithm information. The at least one video signal processing module is configured to store intermediate results in the memory and the frame rate converter is configured to further process the intermediate results using the memory. The at least one video signal processing module comprises a video decoder module. The at least one video signal processing module comprises a deinterlacer. The at least one video signal processing module comprises a scaler.

In general, in another aspect, implementations of the invention may provide a method of processing video signals in a receiver, the method including accessing a single memory from a single integrated circuit chip for use in processing video signals including frame rate conversion of the signals, and coordinating access to the single memory for frame rate conversion of the video signals and at least one of decoding, deinterlacing, and scaling the video signals.

Implementations of the invention may provide one or more of the following features. The method further includes processing the video signals using a single algorithm to perform at least a portion of multiple ones of the decoding, deinterlacing, scaling, and frame rate converting. The deinterlacing includes storing intermediate results to the single memory and the frame rate converting comprises using the intermediate results. The decoding comprises storing intermediate results to the single memory and the frame rate converting comprises using the intermediate results.

Various aspects of the invention may provide one or more of the following capabilities. Board space for video processing can be reduced. Cost for video processing circuitry can be reduced. Redundant storage of video processing information can be reduced. Video back-end processing and frame rate conversion circuitry can have shared functionality/information. Techniques for processing video information can be provided. A single chip can contain back-end video processing modules and a frame rate converter. A single chip can use a single memory for storing information for the back-end processing and for frame rate conversion.

These and other capabilities of the invention, along with the invention itself, will be more fully understood after a review of the following figures, detailed description, and claims.

### BRIEF DESCRIPTION OF THE FIGURES

FIG. 1 is a block diagram of a video system including a transmitter and a receiver.

FIG. 2 is a block diagram of a back-end processor and frame rate converter chip of the receiver shown in FIG. 1.

FIG. 3 is a block flow diagram of processing video signals using the system shown in FIG. 1.

### DETAILED DESCRIPTION

Embodiments of the invention provide techniques for performing back-end processing using a single shared memory. For example, a communication system includes a transmitter and a receiver. The transmitter is configured to transmit information towards the receiver, which the receiver is configured to receive. The receiver includes pre-processing and back-end processing. The pre-processing is configured to process a received signal into a form that can be used during back-end processing. The pre-processing can including using a tuner to select a single broadcast channel of the received signal. The back-end processing includes using several processing modules, a single memory, and a memory controller that is shared by each of the processing modules. The memory controller is configured to receive read and write requests from the several processing modules and is configured to coordinate access to the single shared memory. Other embodiments are within the scope of the invention.

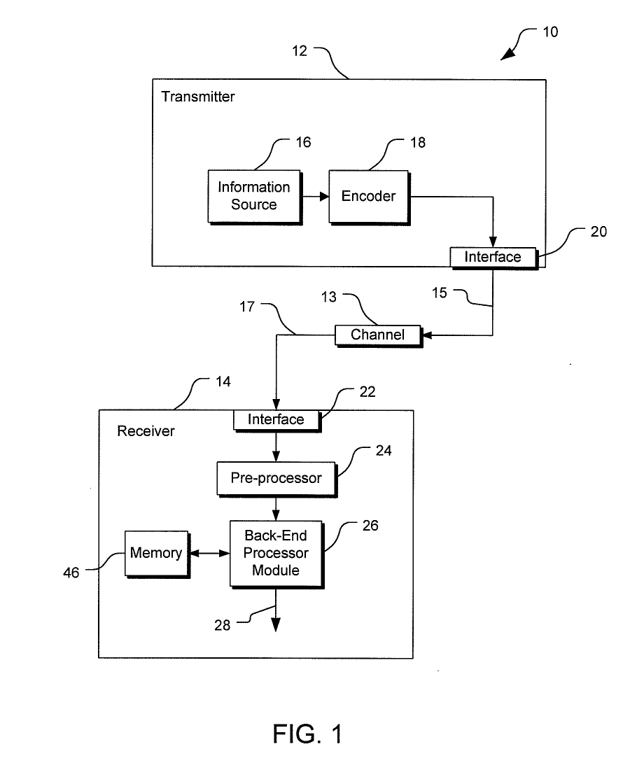

Referring to FIG. 1, a communication system 10 includes a transmitter 12 and a receiver 14. The system 10 also includes appropriate hardware, firmware, and/or software (including computer-readable, preferably computer-executable instructions) to implement the functions described herein. The transmitter 12 can be configured as a terrestrial or cable information provider such as a cable television provider, although other configurations are possible. The receiver 14 can be configured as a device that receives information transmitted by the transmitter 12, such as a high-definition television (HDTV), or a set-top cable or satellite box. The transmitter 12 and the receiver 14 are linked by a transmission channel 13. The transmission channel 13 is a propagation medium such as a cable or the atmosphere.

The transmitter 12 can be configured to transmit information such as television signals received from a service provider. The transmitter 12 preferably includes an information source 16, an encoder 18, and an interface 20. The information source 16 can be a source of information (e.g., video, audio information, and/or data) such as a camera, the Internet, a video game console, and/or a satellite feed. The encoder 18 is connected to the source 16 and the interface 20 and can be configured to encode information from the source 16. The encoder may be any of a variety of encoders such as an OFDM encoder, an analog encoder, a digital encoder such as an MPEG2 video encoder or an H.264 encoder, etc. The encoder 18 can be configured to provide the encoded information to the interface 20. The interface 20 can be configured to transmit the information provided from the encoder 18 towards the receiver 14 via the channel 13. The interface 20 is, for example, an antenna for terrestrial transmitters, or a cable interface for a cable transmitter, etc.

The channel 13 typically introduces signal distortion to the signal transmitted by the transmitter 12 (e.g., a signal 15 is converted into the signal 17 by the channel 13). For example, the signal distortion can be caused by noise (e.g., static), strength variations (fading), phase shift variations, Doppler spread, Doppler fading, multiple path delays, etc.

The receiver 14 can be configured to receive information such as signals transmitted by the transmitter 12 (e.g., the signal 17), and to process the received information to provide the information in a desired format, e.g., as video, audio, and/or data. For example, the receiver 14 can be configured to receive an OFDM signal transmitted by the transmitter 12 that includes multiple video streams (e.g., multiple broadcast channels) and to process the signal so that only a single video stream is output in a desired format for a display. The receiver 14 preferably includes an interface 22, a pre-processor 24, a back-end processor module 26, and a single shared memory 46. While only a single interface 22 and a single pre-processor 24 are shown, the receiver 14 can also include multiple interface/pre-processor combinations (e.g., to receive multiple video signals which are provided to the back-end processor 26). While the single shared memory 46 is shown separate from the back-end processor module 26, the single shared memory 46 can be part of the back-end processor module 26 as well.

The pre-processor 24 is configured to prepare incoming signals for the module 26. The configuration of the pre-processor 24 can vary depending on the type of signal transmitted by the transmitter 12, or can be a “universal” module configured to receive many different types of signals. For example, the pre-processor 24 can include a tuner (e.g., for satellite, terrestrial, or cable television), an HDMI interface, a DVI connector, etc. The pre-processor 24 is configured to receive a cable television feed that includes multiple video streams and to demodulate the signal into a single video stream which can vary depending on user input (e.g., the selection of a specific broadcast channel). The pre-processor 24 can also be configured to perform other pre-processing such as antenna diversity processing and conversion of the incoming signal to an intermediate frequency signal.

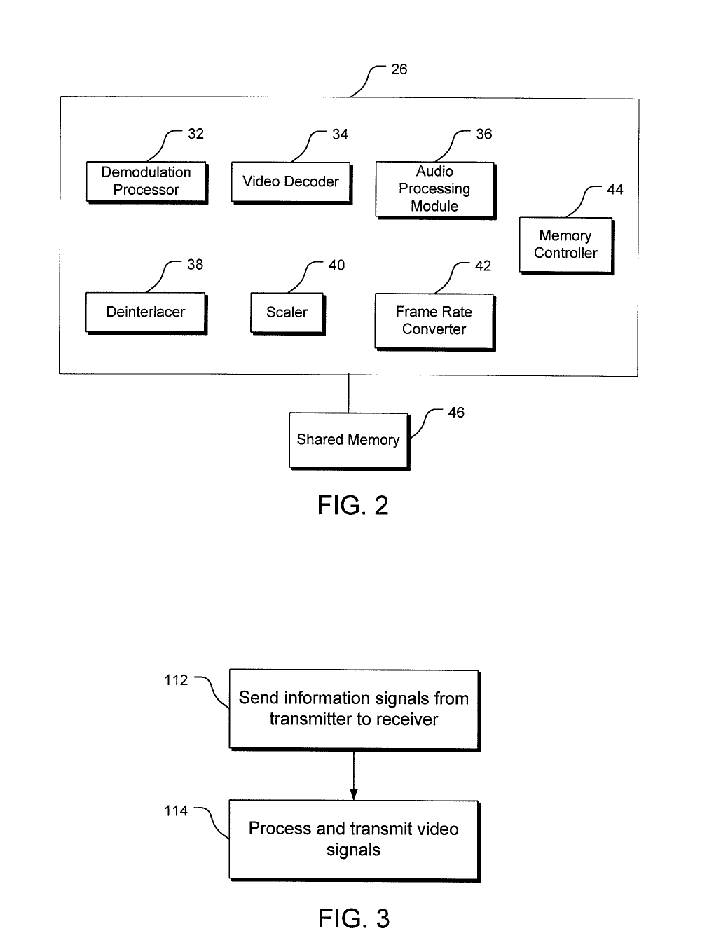

The module 26 is configured to process the information provided by the pre-processor 24 to recover the original information encoded by the transmitter 12 prior to transmission (e.g., the signal 15), and to render the information in an appropriate format as a signal 28 (e.g., for further processing and display). Referring also to FIG. 2, the back-end processing module 26 preferably includes a demodulation processor 32, a video decoder 34, an audio processing module 36, a deinterlacer 38, a scaler 40, a frame rate converter 42, and a memory controller 44. The demodulation processor 32, the video decoder 34, the audio processing module 36, the deinterlacer 38, the scaler 40, the frame rate converter 42, and the memory controller 44 can be coupled together in various configurations. For example, the demodulation processor 32 and the memory controller 44 can be connected directly to each of the video decoder 34, the audio processing module 36, the deinterlacer 38, the scaler 40, and the frame rater converter 42. Furthermore, the memory controller 44 can be coupled directly to the single shared memory 46. The module 26 is connected to the single shared memory 46 that is used for each of the demodulation processor 32, the video decoder 34, the audio processing module 36, the deinterlacer 38, the scaler 40, and the frame rate converter 42.

The components within the module 26 can be configured to provide signal processing. The demodulation processor 32 can be configured to demodulate the signal provided by the pre-processor 24. The decoder 34 can be configured to decode the signal encoded by the encoder 18. For example, the decoder 34 is an OFDM decoder, an analog decoder, a digital decoder such as an MPEG2 video decoder or an H.264 decoder, etc. The audio processing module 36 is configured to process audio information that may have been transmitted by the transmitter 12 (e.g., surround-sound processing). The deinterlacer 38 can be configured to perform deinterlacing processing such as converting an interlaced video signal into a non-interlaced video signal. The scaler 40 can be configured to scale a video signal received from the pre-processor 24 from one size to another (e.g., 800×600 pixels to 1280×1024 pixels). The frame rater converter 42 can be configured to, for example, convert the incoming video signal from one frame rate to another (e.g., 60 frames per second to 120 frames per second).

The back-end processing module 26 is configured to share the single shared memory 46 efficiently between the demodulation processor 32, the video decoder 34, the audio processing module 36, the deinterlacer 38, the scaler 40, and the frame rate converter 42. The module 26 can be configured such that the components use the single shared memory 42 during processing of a video signal. For example, while the demodulation processor 32 processes a video signal, it can use the single shared memory 46 as a buffer. The module 26 can also be configured such that the components use the single shared memory 46 to store processed information for use by other components. For example, the demodulation processor 32 finishes processing a video signal, and it stores the resulting information in the single shared memory 46 for use by the frame rate converter 42. Thus, intermediate data used by the components within the module 26 can be shared using the single shared memory 46.

The back-end processing module 26 can also be configured to share algorithms and/or information between the demodulation processor 32, the video decoder 34, the audio processing module 36, the deinterlacer 38, the scaler 40, and the frame rate converter 42. For example, the back-end processing module 26 can be configured to share algorithms such as cadence detection algorithms, motion information, motion vectors, activity in a frame and/or between frames (e.g., still frame sequence, scene changes, noise level, frequency distribution, luma intensity histograms, etc.) used by the video decoder 34, the deinterlacer 38, and/or the frame rate converter 42. Further examples include:
The deinterlacer 38 can be configured to detect the presence of black borders in a video signal in order to define where an active region of the video signal is. Information indicative of the location of the active region can be stored directly in the single shared memory 46 for use by other components such as the frame rate converter 42 (e.g., so that the frame rate converter 42 only operates on the active video region).
An overlay module can be configured to overlay a menu over a video signal and to store information indicative of the location of the menu overlay in the single shared memory 46. The other components in the back-end processor 26 can be configured not to process the area with the menu overlay using the information stored in the single shared memory 46.
The deinterlacer 38 and the scaler 40 can be configured to assemble images containing multiple video streams (e.g., PiP, PoP, side-by-side, etc.) and to store information related to the multiple video streams in the single shared memory 46. Other components, such as the frame rate converter 42, can be configured to provide processing unique to each of the multiple video streams using the information stored in the single shared memory 46.
The deinterlacer 38 can be configured to perform cadence detection and pulldown removal, and to store information related to both of these processes in the single shared memory 46. The frame rate converter 42 can be configured to use the cadence detection and pulldown information stored in the single shared memory 46 to perform dejittering processing.

The back-end processing module 26 is configured to manage real-time shared access to the single shared memory 46 by the demodulation processor 32, the video decoder 34, the audio processing module 36, the deinterlacer 38, the scaler 40, and the frame rate converter 42. The memory controller 44 can be configured to act as a memory access module to prioritize access to the single shared memory 46 and to resolve collisions in memory access requests. The memory controller 44 can be configured to regulate access by interleaving the access to the single shared memory 46. For example, the decoder 34 can use the single shared memory 46 as a decoder buffer, the deinterlacer 38 can store intermediate data to the single shared memory 46, and the frame rate converter 42 can store frames to the single shared memory 46 for further analysis. The memory controller can be configured to coordinate when access is provided to the single shared memory 46 for writing and reading appropriate information. The access priorities used by the memory controller 44 can vary. For example, the memory controller 44 can use static priorities (e.g., each component is given an assigned priorities), a first-in-first-out method, round-robin, and/or a need-based method (e.g., priority access is given to the component that needs the information most urgently (e.g., to avoid dropping pixels)). Other priority methods are possible.

In operation, referring to FIG. 3, with further reference to FIGS. 1-2, a process 110 for processing video signals using the system 10 includes the stages shown. The process 110, however, is exemplary only and not limiting. The process 110 may be altered, e.g., by having stages added, altered, removed, or rearranged.

At stage 112, the transmitter 12 processes an information signal and transmits the processed information signal towards the receiver 14. The transmitter 12 receives the information signal from the information source 16. The encoder 18 is configured to receive the information signal from the information source 16 and to encode the information signal using, for example, OFDM, analog encoding, MPEG2, H.264, etc. The transmitter 12 is configured to transmit the signal encoded by the encoder 18 towards the receiver 14 via the channel 13.

Also at stage 112, the receiver 14 receives the signal transmitted by the transmitter 12 and performs pre-processing. The interface 22 is configured to receive the signal transmitted via the channel 13 and to provide the received signal to the pre-processor 24. The pre-processor 24 is configured to demodulate (e.g., tune) the signal provided by the transmitter 12. The pre-processor 24 can also be configured to provide other processing functionality such as antenna diversity processing and conversion of the received signal to an intermediate frequency signal.

At stage 114, the back-end processor module 26 receives the signal from the pre-processor 24 and performs back-end processing using the single shared memory 46. The back-end processor module 26 performs signal processing using the demodulation processor 32, the video decoder 34, the audio processing module 36, the deinterlacer 38, the scaler 40, and the frame rate converter 42. For example, the back-end processor module 26 decodes, deinterlaces, scales, and frame rate converts the signal received from the pre-processor 24. The memory controller 44 manages read and write access to the single shared memory 46 by the demodulation processor 32, the video decoder 34, the audio processing module 36, the deinterlacer 38, the scaler 40, and the frame rate converter 42. The memory controller 44 uses a priority scheme to determine the order in which the demodulation processor 32, the video decoder 34, the audio processing module 36, the deinterlacer 38, the scaler 40, and the frame rate converter 42 access the single shared memory. For example, the memory controller 44 assigns an access priority to each of the components included in the back-end processor module 26. The memory controller 44 can also prioritize access requests by determining which of the components most urgently need access to the single shared memory 46. For example, if the memory controller 44 has outstanding memory access requests from the video decoder 34, the deinterlacer 38, and the frame rate converter 42, the memory controller 44 can determine which request is most urgent (e.g., to avoid pixels being dropped).

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. An integrated circuit chip configured to be coupled to a single shared memory comprising, in combination:
a memory access module;
at least one video signal processing module; and
a frame rate converter;
wherein the memory access module is configured to coordinate access to the single shared memory by the at least one video signal processing module and the frame rate converter.

2. The chip of claim 1 wherein the at least one video signal processing module and the frame rater converter are configured to share algorithm information.

3. The chip of claim 1 wherein the at least one video signal processing module is configured to store intermediate results in the single shared memory and the frame rater converter is configured to further process the intermediate results using the single shared memory.

4. The chip of claim 1 wherein the at least one video signal processing module comprises a video decoder module.

5. The chip of claim 1 wherein the at least one video signal processing module comprises a deinterlacer.

6. The chip of claim 1 wherein the at least one video signal processing module comprises a scaler.

7. A digital television receiver comprising:
a memory;
a single integrated circuit chip comprising, in combination:
a memory access module;
at least one video signal processing module; and
a frame rate converter;
wherein the memory access module is configured to coordinate access to the memory by the at least one video signal processing module and the frame rate converter.

8. The receiver of claim 7 wherein the at least one video signal processing module and the frame rate converter are configured to share algorithm information.

9. The receiver of claim 7 wherein the at least one video signal processing module is configured to store intermediate results in the memory and the frame rate converter is configured to further process the intermediate results using the memory.

10. The receiver of claim 7 wherein the at least one video signal processing module comprises a video decoder module.

11. The receiver of claim 7 wherein the at least one video signal processing module comprises a deinterlacer.

12. The receiver of claim 7 wherein the at least one video signal processing module comprises a scaler.

13. A method of processing video signals in a receiver, the method comprising:
accessing a single memory from a single integrated circuit chip for use in processing video signals including frame rate conversion of the signals; and
coordinating access to the single memory for frame rate conversion of the video signals and at least one of decoding, deinterlacing, and scaling the video signals.

14. The method of claim 13 further comprising processing the video signals using a single algorithm to perform at least a portion of multiple ones of the decoding, deinterlacing, scaling, and frame rate converting.

15. The method of claim 13 wherein the deinterlacing comprises storing intermediate results to the single memory and the frame rate converting comprises using the intermediate results.

16. The method of claim 13 wherein the decoding comprises storing intermediate results to the single memory and the frame rate converting comprises using the intermediate results.
